(19) United States
(12) Patent Application Publication
(10) Pub. No.: US 2022/0309154 A1
(43) Pub. Date: Sep. 29, 2022

(54) CYBERSECURITY RISK TRACKING, MATURATION, AND/OR CERTIFICATION

(71) Applicant: Robert A HILL, II, Birmingham, AL (US)

(72) Inventor: Robert A HILL, II, Birmingham, AL (US)

(21) Appl. No.: 17/702,116

(22) Filed: Mar. 23, 2022

Related U.S. Application Data
(60) Provisional application No. 63/164,902, filed on Mar. 23, 2021.

(51) Int. Cl. G06F 21/55

(52) U.S. Cl. CPC G06F 21/552; G06F 2221/034

(57) ABSTRACT

Some aspects of the subject technology are a cybersecurity risk tracking method including steps of associating parameters with activities an organization is required to or should perform, quantitatively classifying cybersecurity compliance with respect to the parameters, identifying deficiencies with respect to the cybersecurity compliance, and reporting at least some of the cybersecurity compliance and deficiencies. The reporting may be via a cybersecurity risk tracker. The method may also include tying at least some of the cybersecurity compliance and deficiencies to a vendor. The vendor also may be reported via the cybersecurity risk tracker. In preferred aspects, an adaptive risk model is used to identify the deficiencies. The subject technology also includes systems configured to perform the above techniques.

### CROSS-REFERENCE TO RELATED APPLICATION

This application claims the benefit of U.S. Provisional Application No. 63/164,902, filed 23 Mar. 2021, with the same title and inventor as this non-provisional application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND

The present disclosure generally relates to cybersecurity risk tracking, maturation, and/or certification.

### SUMMARY

Some aspects of the subject technology are a cybersecurity risk tracking method including steps of associating parameters with activities an organization is required to or should perform, quantitatively classifying cybersecurity compliance with respect to the parameters, identifying deficiencies with respect to the cybersecurity compliance, and reporting at least some of the cybersecurity compliance and deficiencies. The reporting may be via a cybersecurity risk tracker.

The method may also include tying at least some of the cybersecurity compliance and deficiencies to a vendor. The vendor also may be reported via the cybersecurity risk tracker. In preferred aspects, an adaptive risk model is used to identify the deficiencies.

The subject technology also includes systems configured to perform some or all of the above techniques.

This brief summary has been provided so that the nature of the invention may be understood quickly. Additional elements, steps, different elements, and/or different steps than those set forth in this summary may be used. A more complete understanding of the invention may be obtained by reference to the following description in connection with the attached drawings.

### BRIEF DESCRIPTION OF THE DRAWINGS

FIG. 2.1 illustrates client selection according to aspects of the subject technology.

FIG. 3.1 illustrates practice details according to aspects of the subject technology.

FIG. 3.2 illustrates CRT (Customer Risk Tracker) architecture according to aspects of the subject technology.

FIG. 3.3 illustrates implementation response according to aspects of the subject technology.

FIG. 4.1 illustrates an example adaptive risk model (ARM) according to aspects of the subject technology.

FIG. 4.2 illustrates cross functional data management according to aspects of the subject technology.

FIG. 4.3 illustrates a CMI (Cyber Maturity Index) score according to aspects of the subject technology.

FIG. 4.4 illustrates a CMI visual representation according to aspects of the subject technology.

FIG. 4.5 illustrates scoring calculations according to aspects of the subject technology.

FIG. 4.6 illustrates group analysis according to aspects of the subject technology.

FIG. 4.7 illustrates managed practices according to aspects of the subject technology.

FIG. 4.8 illustrates grouping and management of practices according to aspects of the subject technology.

FIG. 4.9 illustrates display of project delivery in a format according to aspects of the subject technology.

FIG. 5.1 illustrates a risk register according to aspects of the subject technology.

FIG. 5.2 illustrates risk detail according to aspects of the subject technology.

FIG. 5.3 illustrates mitigation detail according to aspects of the subject technology.

FIG. 5.4 illustrates contingency plan detail according to aspects of the subject technology.

FIG. 5.5 illustrates an impact matrix according to aspects of the subject technology.

FIG. 5.6 illustrates a third-party and vendor repository according to aspects of the subject technology.

FIG. 5.7 illustrates vendor and supply management according to aspects of the subject technology.

FIG. 5.8 illustrates vendor risk assessment management according to aspects of the subject technology.

FIG. 5.9 illustrates vendor risk assessment (VRA) according to aspects of the subject technology.

FIG. 6 illustrates one possible infrastructure for implementation of the subject technology according to aspects of the subject technology.

### DETAILED DESCRIPTION

U.S. Provisional Application No. 63/164,902, filed 23 Mar. 2021, with the same title and inventor as this non-provisional application, is hereby incorporated by reference as if fully set forth herein.

Some aspects of the subject technology are a cybersecurity risk tracking method including steps of associating parameters with activities an organization is required to or should perform, quantitatively classifying cybersecurity compliance with respect to the parameters, identifying deficiencies with respect to the cybersecurity compliance, and reporting at least some of the cybersecurity compliance and deficiencies. The reporting may be via a cybersecurity risk tracker. The method may also include tying at least some of the cybersecurity compliance and deficiencies to a vendor. The vendor also may be reported via the cybersecurity risk tracker. In preferred aspects, an adaptive risk model is used to identify the deficiencies.

The subject technology also includes systems configured to perform some or all of the above techniques.

The following is a description of some embodiment(s) of the subject technology.

### 1. INTRODUCTION

The Compliance and Risk Tracker (CRT) is the compilation of decades of experience coupled with over five years of focused development work. What started as an innovation to the Integrated Compliance and Risk Management industry as well as an application for the emerging Managed Cybersecurity and Compliance Providers, has evolved into the most advanced and industry-leading SaaS application by revolutionizing an organization's ability to manage their compliance and risk in a single application. This may include, but is not limited to, any compliance framework and/or regulatory requirement, integrated Risk Register, 3rd-party and Vendor Risk Management, Policy Lifecycle Management, and Incident Response.

### 2. PROBLEMS SOLVED

Previous solutions in this space relied heavily on application implementations specific to the organization utilizing the application instance. Additionally, the application was tied to the organization and the configurations associated within that instance. Lastly, the organizations resources were responsible for ongoing system updates and maintenance along with data ingestion within the system, thereby minimizing the value to the organization and increasing the opportunity for inaccurate status reporting.

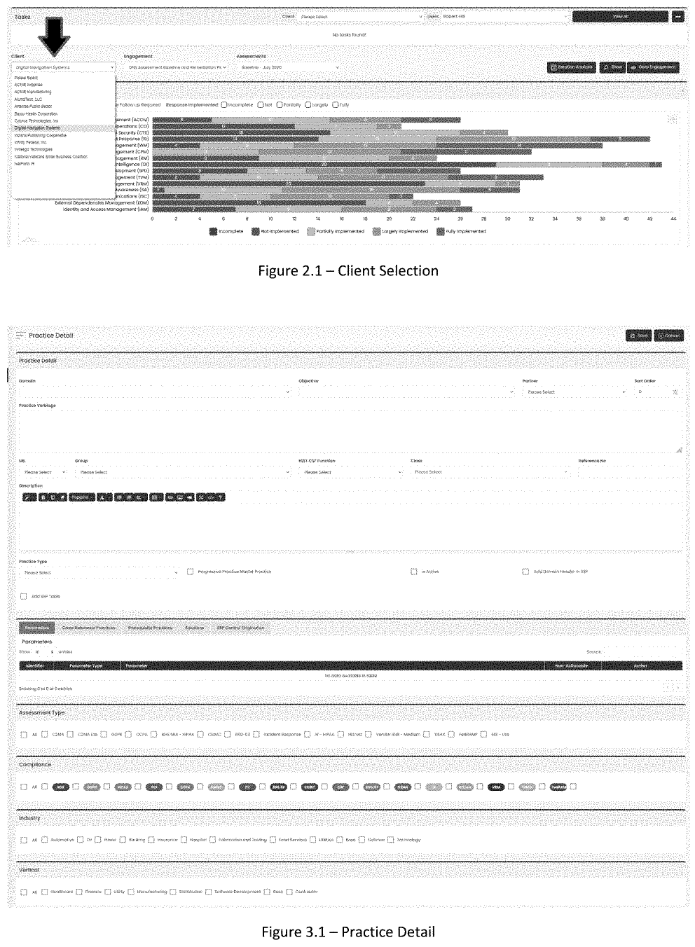

Departing from the industry standard, the subject CRT was initially designed to be framework agnostic simplifying adoption of future frameworks, delivered as a Software as a Service model, reducing deployment time and providing the ability to manage an unlimited number of clients (FIG. 2.1) and associated compliance engagements within a single instance of the CRT. In addition, the CRT can be white labeled allowing consulting entities to leverage this functionality to manage the compliance and risk postures for their portfolio of clients in a single application instance. See FIG. 2.1.

These elements designed into the CRT core is intended to solve many of the inherent problems of our industry not previously addressed. Many emerging cybersecurity frameworks, including the CMMC (Cybersecurity Maturity Model Certification) from the DOD as an example, require an external entity to perform an assessment and establish an unbiased maturity score. Using a locally implemented and configured application limits the ability to meet these criteria. The CRT is intended to solve this limitation with a solution currently unavailable in other existing applications.

### 3. TAXONOMY

In a deviation from the industry standard, the patent applicant uses a taxonomy vs a topology. By definition, a topology is subjective, conceptual, reasoned by deduction and mostly qualitative classifications. Conversely, a taxonomy is objective, empirical, reasoned by inference and uses quantitative classifications. The CRT taxonomy attempts to classify compliance frameworks within Domains, Objectives, and/or Practices related within the structure. These

Practices preferably can have a virtually unlimited number of Parameters associated. This taxonomy structure enables a controlled and measured approach to all current and future compliance frameworks.

### 3.1. Domains

A Domain preferably contains a structured set of cybersecurity Practices. Each set of Practices represents the activities an organization is required to perform (or should perform based on the framework) to establish and mature capability within the Domain. For example, the Risk Management Domain is a group of practices that an organization performs to establish and mature their Cybersecurity Risk Management capability.

For each Domain, the CRT is intended to provide a purpose statement, derived from the specified framework, which is a high-level summary of the intent of the Domain. The purpose statement offers context for interpreting the Practices within the Domain.

### 3.2. Objectives

Practices within each Domain preferably are further organized into Objectives, which represent achievements that support the Domain. For example, the C2MA Risk Management Domain comprises three objectives:
Establish Cybersecurity Risk Management Strategy
Manage Cybersecurity Risk
Management Practices

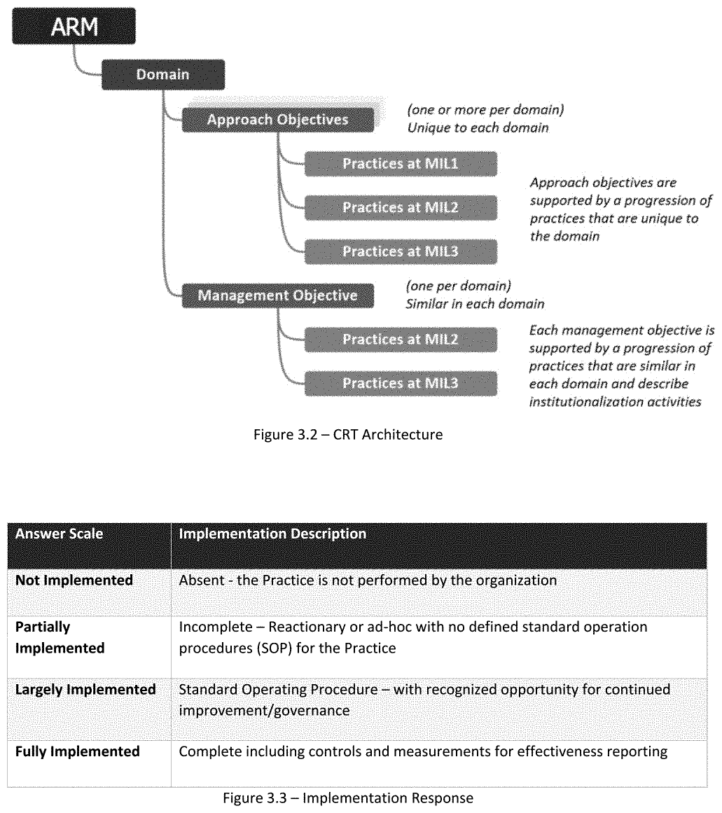

Each of the Objectives in a Domain preferably comprises a set of Practices, which are ordered by Maturity Indicator Level (MIL). FIG. 3.1 depicts the architecture defined by some embodiments of the CRT.

### 3.3. Practices

The Domains preferably are the top level of the architecture followed by the Objectives which organize the Practices. The Practices should consist of the controls, governance, procedures, processes, and/or activities performed by the organization and/or resources of the organization. Unique to some embodiments of the CRT are the attributes assigned to the Practice as indicated in FIG. 3.1.

The flexibility provided by the attributes should enable the inclusion of System Security Plan (SSP) details, NIST CSF Framework correlation, Group inclusions for systemic analysis within an organization, and/or Practices specific to Industries and/or Verticals. In addition, this configuration preferably enables a Practice to be used by multiple compliance frameworks or be tied via cross-reference to similar compliance requirements. Parameters should also be handled at the Practice level allowing a virtually unlimited number of Parameters to be set each with varying compliance requirements.

In some embodiments, Practices can also be configured as “progressive” with separate child Practices based on the Implementation Response of the Parent. Practices can be nested allowing a unique assessment progression based on the organizational responses.

Lastly, Practices can be tied to technical solutions enabling recommendations based on the technical partner engaging with the client. This functionality should assist the client in selecting solutions that meet their needs across many deficient practices providing a greater range of remediation per solution.

### 3.4. Class

Many frameworks preferably have Certification or Risk Criticality Levels associated within the framework. The CRT taxonomy can take these requirements into account by assigning a Class attribute at each Practice Level. This attribute should be utilized by the CRT to define Practice inclusion into an Assessment based on the Level being sought by the Organization limiting the Assessment Practices to only those required by a specific Class. This functionality is intended to support frameworks with High, Medium, Low Levels as well as numeric 1,2,3 etc. Certain European frameworks utilize a Must, Should, High, and Very High for which the CRT can also accommodate.

### 3.5. Maturity Level Indicator

To measure progression of the specific activities within a framework, maturity models typically define levels to establish a scale. The patent applicant uses a scale of maturity indicator levels (MILs) 1-3. A set of attributes preferably defines each maturity level. If an organization demonstrates these attributes, it has achieved both that level and the capabilities represented within that level. Having measurable transition states between the levels is intended to enable an organization to use the scale to:
Define its current state (Establish a baseline)
Determine its future, more matured state (Set goals and objectives)
Identify the capabilities it must attain to reach that future state (Generate a roadmap)

See FIG. 3.2.

### 3.6. Implementation Response

When developing the CRT capability to produce a quantitative result, the patent applicant expanded the industry standard response of Implemented or Not Implemented into a defined four answer Status. This enables a mathematical value to be set to each response. The accepted responses as well as the associated description are listed in FIG. 3.3.

### 4. Core Functionality

The risk management industry has traditionally been filled with point products. Some products covered managing a risk register, some managed third-party and vendor risk management, others performed compliance reviews and assessments, while still others managed policy life cycle within the organization. The subject CRT is intended to bring a synergy to each of these various Risk Management point solutions with a previously unseen lifecycle designed into the core of the application without the requirement of individual implementations of various solutions while offering multipoint integration. As an example, a deficiency can be detected through a data ingestion assessment which can initiate the creation of a Risk on the Risk Register. This Risk as well as the deficiency preferably can be aligned within the CRT to an organizational Policy, managed in the integrated Policy Manager, which addresses this finding. In some embodiments, the Risk can then, if applicable, be tied to a specific (or multiple) Vendors, within the integrated Vendor Management module through which remediation is tracked and documented. Additionally, an internal project preferably can be initiated to provide managed resolution to the initially discovered deficiency. All these various moving parts and activities should be tracked, managed, assigned, tasked, and/or reported from the single CRT platform preferably negating the necessity of multiple applications and associated implementations.

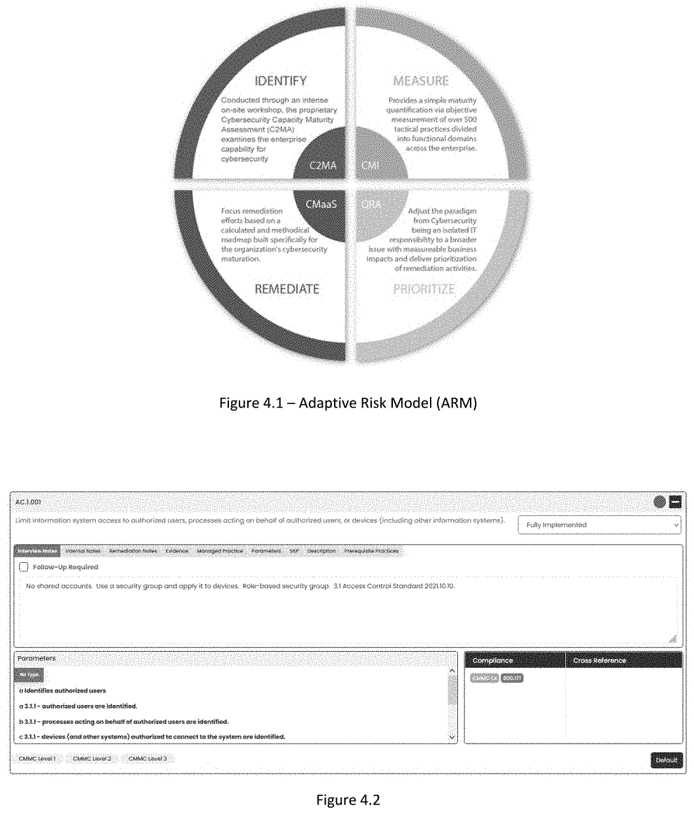

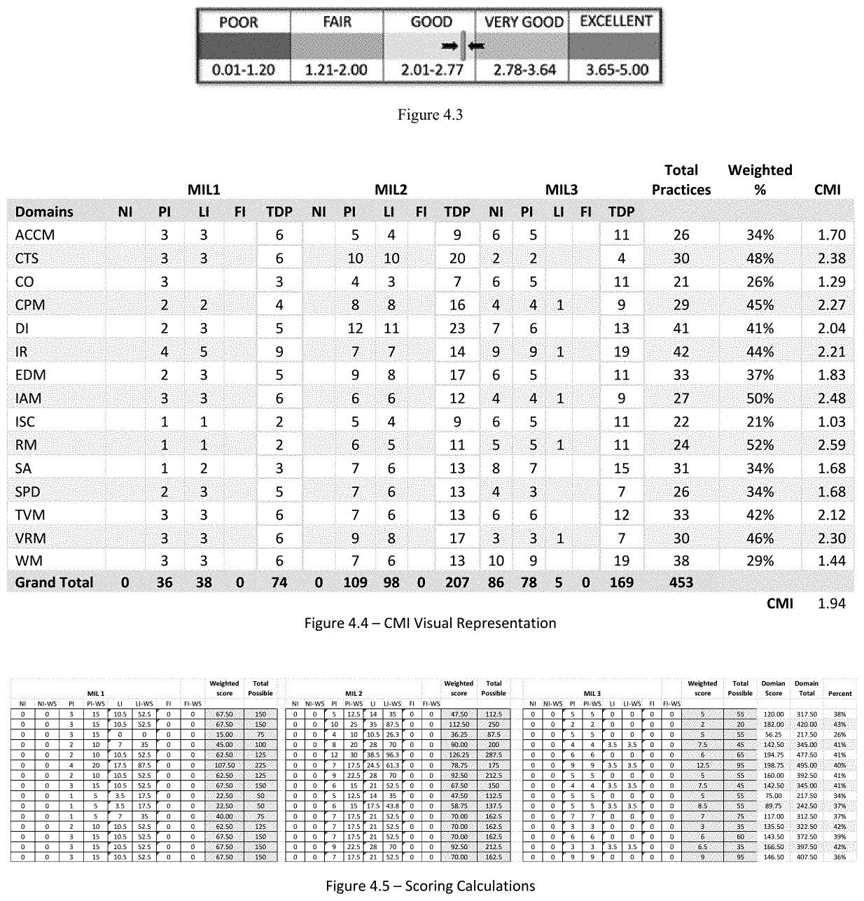

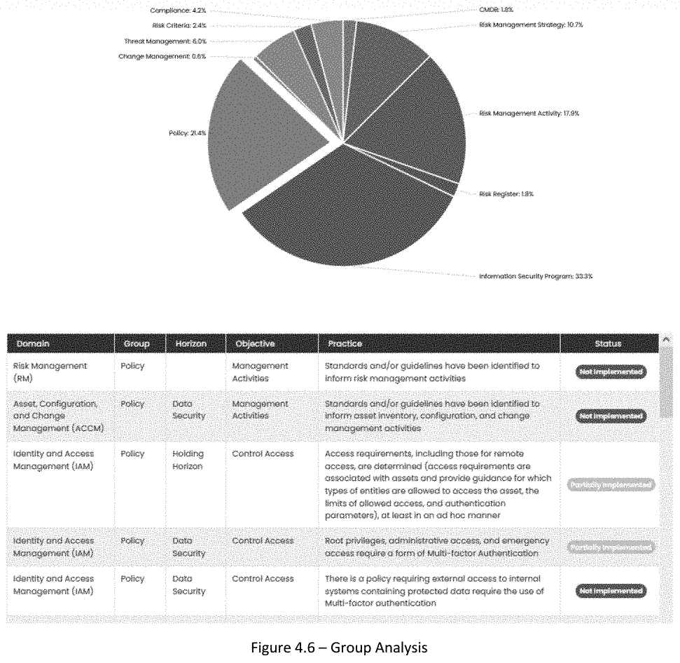

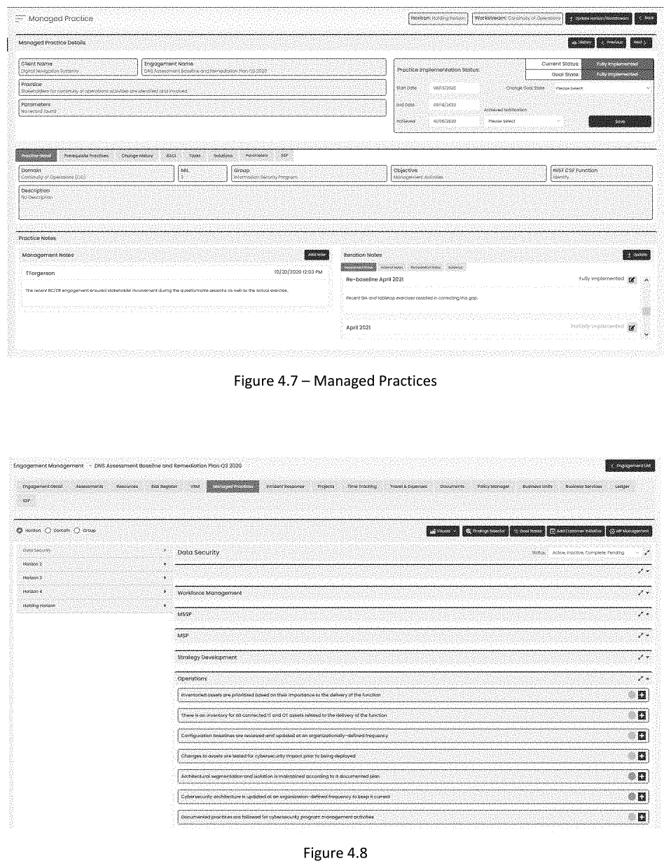

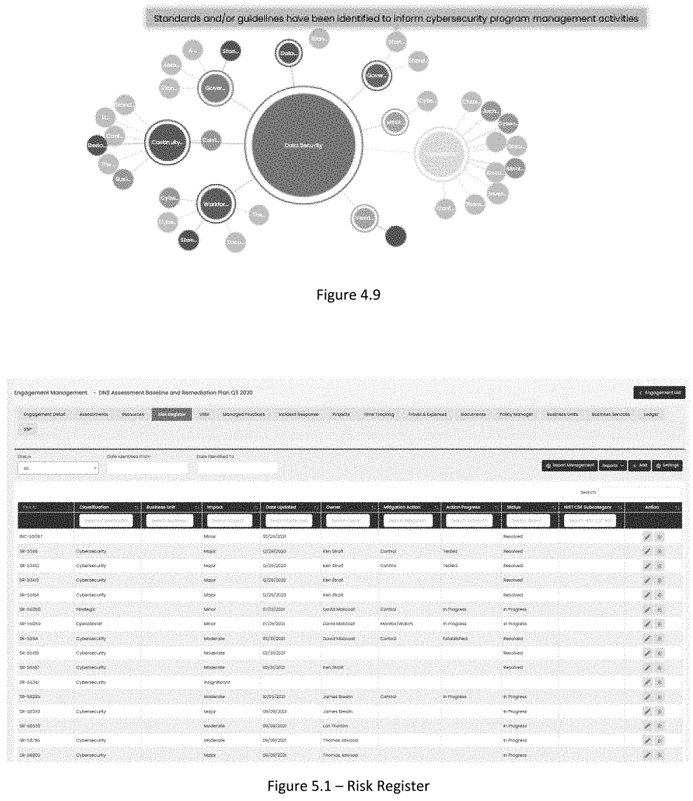

The core functionality of the CRT should be based on the proprietary Adaptive Risk Model (ARM). The ARM model, FIG. 4.1, incorporates the Identification through our Data Ingestion workshop process, Measurement through the proprietary Cyber Maturity Index, Prioritization through our Quantitative Risk Analysis (QRA) process, and managed Remediation through our Cyber Maturation as a Service (CMaaS).

This unique and proprietary risk model is intended to provide agnostic flexibility for any organization in any industry/vertical at any maturity state to establish a compliance baseline to any framework and define a corrective baseline based on the highest potential impacts to the delivery of their business services.

### 4.1. ARM Process Explained

The four quadrants (Identify, Measure, Prioritize, and Remediate) of the proprietary ARM process in some embodiments are explained in more detail below.

Identify—Data Ingestion

An organization doesn't know what it doesn't know. It all starts with an assessment tied to a framework. The CRT preferably is framework agnostic and can accommodate current frameworks, easily ingest future frameworks, and/or manage the enhancements and versioning of existing frameworks. This unique flexibility is intended to enable the CRT to be future proof and eliminates the need for extensive development or reconfiguration as frameworks change or are constantly being added in our industry. The baseline assessments preferably are client specific based on industry, vertical, and/or compliance requirements. Unlike traditional audits, these data ingestion baseline assessments should be designed to uncover deficiencies and gaps while setting the organization up for remediation success. The CRT platform preferably provides crosswalks and accommodates organizations with multiple varying compliance requirements, reducing the assessment impact by reusing the provided data points for multiple applicable compliance frameworks within the organization. The CRT is intended to solve the existing pain point for organizations attempting to manage multiple compliance requirements effectively.

During the Data Ingestion activities, some embodiments of the CRT platform enable the management of many data streams including implementation status, interview notes, internal notes, remediation activity, horizon/workstream management, as well as solutions, parameters, and SSP details at the individual Practice level to improve efficiencies and reduce work efforts associated with data ingestion and baseline creation. See FIG. 4.2.

This cross functional data management is believed to be unique in the industry enabling a full compliance crosswalk as well as cross referencing between differential frameworks while managing the ancillary data necessary for measured improvement.

Measure—Cyber Maturity Index

The patent applicant was the first to leverage the concepts of response implementation quantification as well as maturity indicator level in an agnostic approach enabling these overlays to be applied to any existing or future compliance framework. The unique application of these combined measurement methodologies is intended to create an exclusive functionality that had previously not been available in the industry, providing the ability to measure, quantify, and/or define a true maturity indicator for any organization. Assigning numerical values to these implementation quantification methodologies is intended to enable a reliable and repeatable maturity measurement. Leveraging this previously unobtainable measurement capability, a proprietary mathematical algorithm was created to provide a reference score that denoted a quantifiable numerical representation of an organization's current maturity.

The patent applicant named the score the Cyber Maturity Index (CMI). This proprietary CMI score may be limited to a scale range of 0-5 with two decimal places as indicated in FIG. 4.3.

The table in FIG. 4.4 denotes the Maturity Indicator Levels in relation to the Domains to indicate the ability of the CRT to create a score based on the Response Quantification (NI—Not Implemented PI—Partially Implemented LI Largely Implemented FI —Fully Implemented) within the specific MILs.

FIG. 4.5 denotes the mathematical scoring preferably used in the calculation of the CMI Score.

In addition to the CMI measurement, analysis of the findings should continue through a proprietary grouping of the Practices beyond the specific Domains in which they reside constrained by the framework. This is intended to enable the detection of systemic deficiencies at an organizational level. The chart illustrated in FIG. 4.6 indicates this organization has a systemic issue with governance management encompassing most Domains in the specified framework.

In a typical audit/assessment this granular cross Domain analysis is not supported within a standard compliance framework. Some embodiments of the CRT platform provide the overlay enabling this functionality within any framework ingested into the platform. The results of this in-depth Practice data grouping analysis process combined with the proprietary CMI algorithms should be reviewed against the potential impacts to the delivery of organizationally identified business services. This is intended to provide the basis for Prioritizing the findings into an organizationally specific remediation roadmap.

Prioritize—Quantitative Risk Analysis

The CRT should utilize a QRA process known as Sensitivity Analysis to determine which deficiencies (risks) have the greatest potential impact on the organization's ability to deliver business services. Most Risk Assessments focus on the avoidance of threats, detection of incidents, and vulnerability remediation. None of these methods take into consideration what is of value or significant importance to the organization.

Sensitivity analysis is the quantitative risk assessment of how changes in a specific model variable impacts the output of the model. The CRT is the first to apply this approach, typically reserved for Project Management, into the prioritization of remediation activities. The construct of rank order correlation may be used not only to for sensitivity analysis, but also incorporated into the calculation of risk score as well as cruciality and success rate analysis. This sensitivity analysis preferably includes determining the value of a deficiency parameter that makes two alternative outcomes equivalent, whereas the CMI risk analysis includes a percent change in the deficiency parameters. Some embodiments of the CRT also factor organizational Risk Appetite and Risk Tolerance where Risk Appetite is the general level of risk a company accepts while pursuing the delivery of business services/objectives before it decides to take action to reduce that risk, and Risk Tolerance is the mathematical variance from its Risk Appetite that the organization is willing to tolerate. Through the combined analysis of the deficiencies against the potential impact to delivery of business services guided by the organizational Risk Appetite and Tolerance, the CRT is intended to prioritize the remediation efforts of the organization.

Remediation—Cyber Maturation as a Service

The Adaptive Risk Model (ARM) designed into the core of the CRT platform should enable Cyber Maturation as a Service (CMaaS) as the fulfillment of the fourth and final ARM quadrant. CMaaS, and the associated subscription service, was conceived and devised by the patent applicant as a solution to the legacy problem with annual audits/assessments with minimal change between iterations. Organizations struggled with ingesting the findings, developing projects, managing the deliverables, enacting the changes, and then recognizing positive results before another assessment/audit was required. The CMaaS concept is intended to remove the annual re-assessment necessity and replaces it with monthly iterations of the improvements to the initial baseline enabling the visualization of trending change over time. Instead of external consultants spending weeks determining the changes on a painful annual schedule, the organization should adopt a continuous improvement process powered by the CRT Dynamic Risk Assessment (DRA) capabilities. Through the CMaaS functionality, this DRA should be delivered in an on-going basis eliminating the necessity for individual annual assessments usually performed on Excel spreadsheets. This functionality was developed by the patent applicant and is an exclusive offering of some embodiments of the CRT platform.

### 4.2. Practice Maturation Management

The CRT is intended to provide an integrated project management engine enabling the efficient organization of work efforts associated with the remediation of findings and maturation of practices. Previous risk or compliance management tools relied on the utilization of spreadsheets or external project management applications. With the integration of enterprise grade project management capabilities, some embodiments of the CRT can manage the maturation of individual compliance Practices and the associated variables including prerequisites, tasks, and RACI. These functions may be enhanced by robust notes capabilities and Implementation Status management. See FIG. 4.7.

This integrated project management functionality is intended to enable Practices to be combined into Horizons and Workstreams empowering effective and efficient grouping and management of similar Practices. See FIG. 4.8. These Horizons, Workstreams and Practice status can be displayed in various formats for project status deliver to senior management. See FIG. 4.9.

### 5. CRT Modules

Some embodiments of the Compliance and Risk Tracker integrate not only the assessment and subsequent remediation life cycle, but also perform many additional functions in an effort to manage Risk in an organization. These additional modules preferably are part of the integrated CRT platform, and while complementary, preferably are not required for delivery of the previously documented core functionality. They can be initialized individually or as a group.

### 5.1. Risk Register

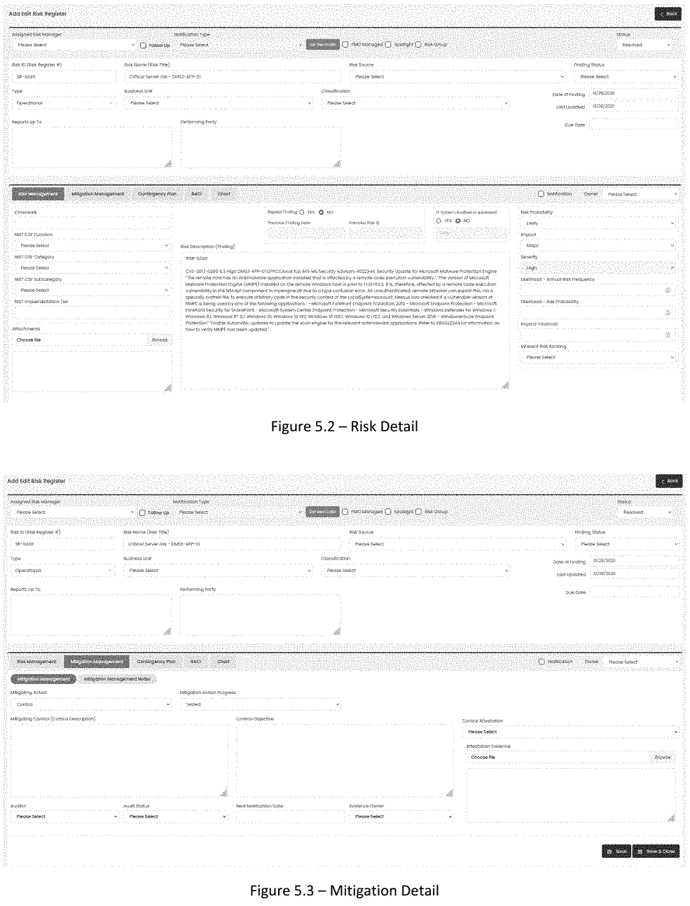

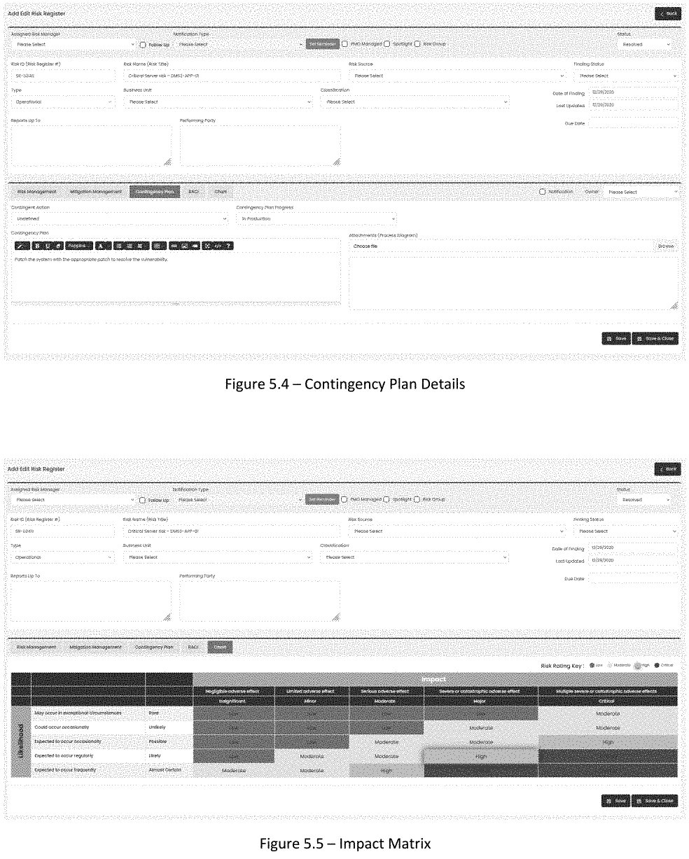

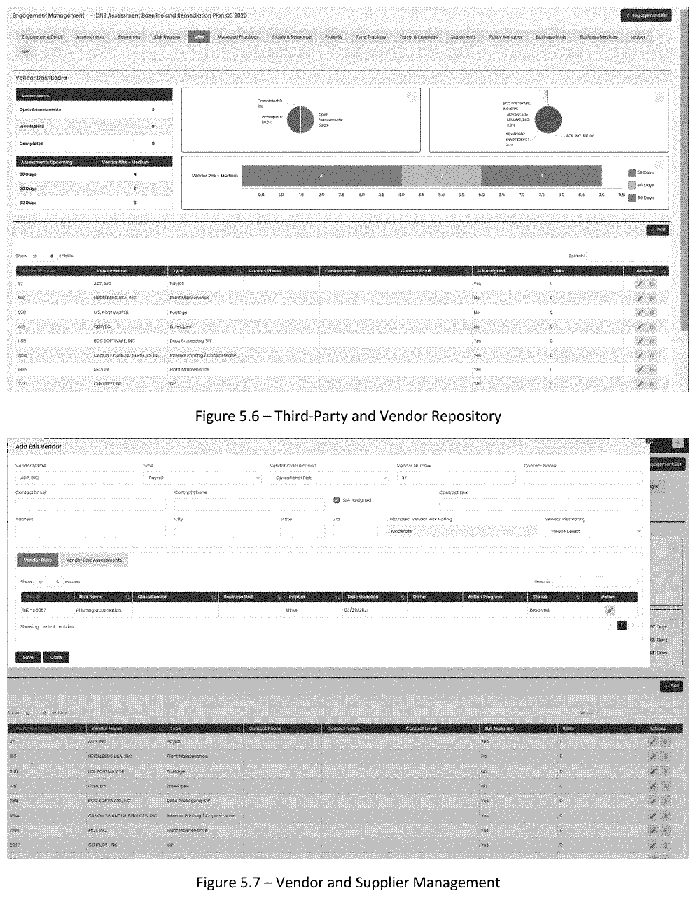

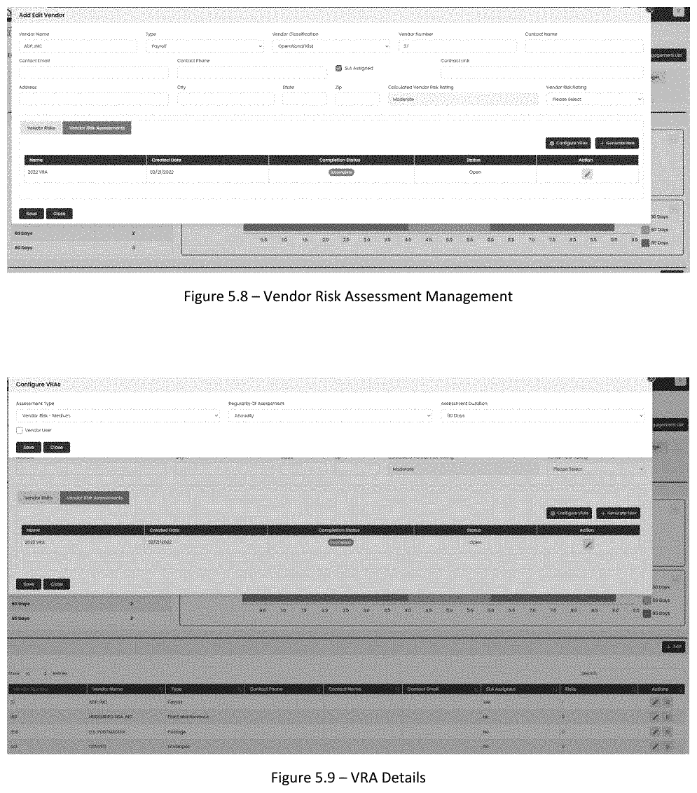

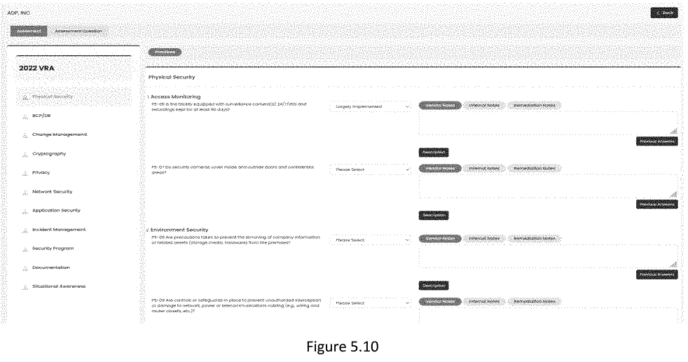

The CRT Risk Register module is intended to provide a centralized repository for the collection and management of cyber security risks to the organization. These risks can be associated with multiple framework findings, business deficiencies, vendors, threats, and/or vulnerabilities just to name a few categories. This simple yet efficient full featured centralized repository should enable most organizations to mature beyond spreadsheet management of corporate cyber security risk. Risks can be categorized by, but not limited to, Classification, Impact Mitigation Action, Status, or Type. See FIG. 5.1.

An individual risk can be managed by the assigned Risk Owner or a designated Risk Manager. Some embodiments of the CRT offer exclusive features for risk management which include PMO managed risks, placed into Risk Groups or Spotlighted for Executive visibility and overview. See FIG. 5.2 for additional detail.

In addition to performing the functions of a central risk repository, some embodiments of the CRT integrated Risk Register Module also include Mitigation Management and Contingency Planning. The Mitigation Management functions should include management of the attestation lifecycle and associated audit tasks as shown in FIG. 5.3.

Contingency Planning requires an organization to mature beyond simple mitigation of an identified risk and allows the organization the ability to think through the potential impacts if/when a mitigation fails. The CRT Risk Register is intended to incorporate the functionality to assist an organization in taking that maturation step and defining a Contingency Plan, Process Diagram, and/or associated actions. See FIG. 5.4 for Contingency Details.

The CRT Risk Register preferably includes the auto generation of the Impact/Likelihood to Severity Matrix. See FIG. 5.5.

### 5.2. Third-Party and Vendor Risk Management

Third-party and vendor risk management (3PVRM) is a critical element in an organizational maturation process. Some embodiments of the CRT incorporate a 3PVRM module providing a central repository and management structure for all vendors and suppliers. These vendors and suppliers can be arranged by an organization specific topology and classification system. See FIG. 5.6.

This 3PVRM repository is intended to maintain vendor details enabling rapid access to critical data during an event or incident. Risks from the integrated Risk Register module (previously discussed above) can be attached to one or more vendors providing a comprehensive view of the risks introduced by the various vendors. This integration to the framework Practices as well as to the organizational Risk Register is unique to some embodiments of the CRT. This functionality generally requires multiple diverse applications with complicated integrations. Some embodiments of the CRT require no implementation and no integration to utilize this advanced maturity functionality. As seen in FIG. 5.7, there can be an automated calculation of the Vendor Risk Rating based on the associated Risks from the Risk Register. The Risk Manager preferably has the option to assign a manual Risk Rating enabling the associated Vendor Risk Assessments (VRA) to be engineered into a higher category of assessment based on factors beyond the associated Risks.

These Risk Ratings are intended to drive Vendor Risk Assessment (VRA) configurations. Based on the organizational requirements, VRAs can be configured as simply as High, Medium, and Low with each having a differential depth to the assessment or as complicated as necessary taking into consideration required frameworks, regulatory compliance, and industry/vertical. These various assessments preferably are managed with the Third-Party and Vendor Risk Management module. See FIG. 5.8.

Vendor Risk Assessments can be easily configured with options of Assessment frequency and duration. See FIG. 5.9 for details.

Once a VRA has been sent to the vendor portal and access granted to the Vendor, ongoing management of the VRA may be performed within the module. Vendor effort, notes, and remediation efforts preferably are all centrally managed. See FIG. 5.10.

Some embodiments of the CRT 3PVRM module enable the maturation of an organization's Third-Party and Vendor Risk Management program, which is a requirement in many legacy and most recent regulatory frameworks. This subject technology's integrated, intuitive, and feature rich module is a unique offering due to the simplicity of implementation and speed to recognize value in reducing organizational risk. Organizations can link deficient framework Practices, Risk Register risks, business service delivery, and/or Policies to inform a common risk picture.

### 5.3. Policy Manager

The most recent addition to some embodiments of the CRT is the Policy Management module. Many organizations struggle with managing the life-cycle of Governance. Policies can generally be found in shared folders, dedicated policy applications, SharePoint, and physical 3- ring binders. None of the before mentioned common solutions provide the ability to establish a structure for an automated approval notification process, revision and version management, linking to associated regulatory compliance requiring the attestation of Policy documentation, and deficiency management in the remediation of Governance related findings. The CRT Policy Management module is intended to provide all these capabilities and more. Some embodiments of this module provide a central repository for Policies required by the various regulatory frameworks and improves efficiencies by linking to the Practices within those frameworks. During an external compliance audit, evidence collection should be a simple button push and the associated Policy should be exported with references as a PDF. This is intended to enable the reuse of organizational Governance to accommodate the requirements of many divers regulatory frameworks.

Many Policies require an annual review and approval. Some embodiments of the CRT Policy Management module feature a Governance life-cycle incorporating the separation of duties between a Policy Owner and a Policy Approver. The organization can establish a Policy life expectancy and the CRT performs the associated activities of notification, follow-up, and facilitating the approval process.

Integration of Policy Management is the next clear evolutionary step in Integrated Risk Management. The CRT is intended to be the first to accomplish true incorporation into the compliance management and attestation process inclusive of all regulatory frameworks delivering the full life cycle within a single platform.

### 6. Infrastructure

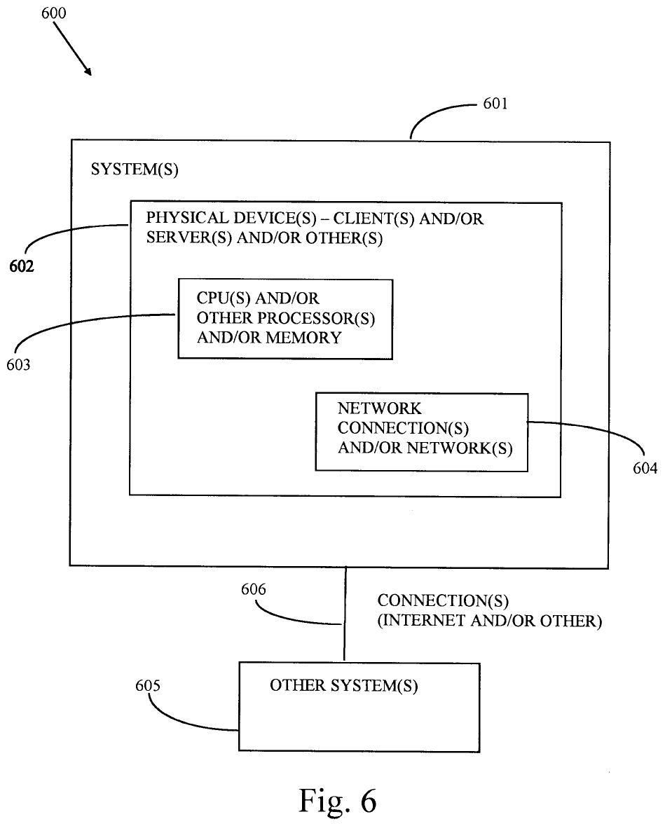

FIG. 6 shows one possible infrastructure for implementation of aspects of the subject technology. System 600 may include system(s) 601. These system(s) may include physical device(s) 602 such as client(s) and/or server(s) and/or other device(s) 602. These client(s) and/or server(s) and/or other device(s) 602 preferably include tangible computing elements such as CPU(S) and/or other processor(s) 603 and/or memory that collectively perform the functions described above. Also included may be network connection(s) and/or network(s) 604. System(s) 601 may also interact with other system(s) 605, possibly configured akin to system(s) 601. System(s) 601 and system(s) 605 may communicate via connection(s) 606, for example the Internet and/or other connection(s). Some or all of these elements may perform and/or interact to facilitate the functions described above.

### 7. Conclusion

The Compliance and Risk Tracker platform is the premier Integrated Risk Management platform. Leveraging the dynamic Adaptive Risk Model (ARM) as the foundation to bringing together diverse functionalities into a single platform, the Compliance and Risk Tracker (CRT) uniquely transforms organizational risk management and compliance remediation into a single unified entity providing granular detail and task management related to maturation improvement and mandated compliance requirements while simultaneously providing an enterprise business perspective based on the potential impact to the delivery of critical business services. This is true Cyber Risk Quantification . . . simplified.

The invention is in no way limited to the specifics of any particular aspects disclosed herein. For example, the terms “aspect,” “some embodiments,” “example,” “preferably,” “alternatively,” “should,” “can,” “may,” “intended,” and the like denote features that may be preferable but not necessarily essential to include in some embodiments of the invention. Details illustrated or disclosed with respect to any one aspect of the invention may be used with other aspects of the invention. Additional elements and/or steps may be added to various aspects of the invention and/or some disclosed elements and/or steps may be subtracted from various aspects of the invention without departing from the scope of the invention. Singular elements/steps imply plural elements/steps and vice versa. Some steps may be performed serially, in parallel, in a pipelined manner, or in different orders than disclosed herein. Many other variations are possible which remain within the content, scope, and spirit of the invention, and these variations would become clear to those skilled in the art after perusal of this application.

What is claimed is:

1. A cybersecurity risk tracking system, comprising:
at least one computing device including one or more tangible computing elements that perform steps comprising:
associating parameters with activities an organization is required to or should perform;
quantitatively classifying cybersecurity compliance with respect to the parameters;
identifying deficiencies with respect to the cybersecurity compliance; and
reporting at least some of the cybersecurity compliance and deficiencies.

2. A system as in claim 1, wherein the reporting is via a cybersecurity risk tracker.

3. A system as in claim 1, wherein the steps further comprise tying at least some of the cybersecurity compliance and deficiencies to a vendor.

4. A system as in claim 1, wherein the vendor is reported via a cybersecurity risk tracker.

5. A system as in claim 1, wherein the step of identifying deficiencies uses an adaptive risk model.

6. A method of performing cybersecurity risk tracking, comprising steps of:
associating parameters with activities an organization is required to or should perform;
quantitatively classifying cybersecurity compliance with respect to the parameters;
identifying deficiencies with respect to the cybersecurity compliance; and
reporting at least some of the cybersecurity compliance and deficiencies.

7. A method as in claim 6, wherein the reporting is via a cybersecurity risk tracker.

8. A method as in claim 6, wherein the steps further comprise tying at least some of the cybersecurity compliance and deficiencies to a vendor.

9. A method as in claim 6, wherein the vendor is reported via a cybersecurity risk tracker.

10. A method as in claim 6, wherein the step of identifying deficiencies uses an adaptive risk model.
